(19) United States
(12) Patent Application Publication
(10) Pub. No.: US 2005/0021820 A1
(43) Pub. Date: Jan. 27, 2005

(54) Controlling the traffic of a communications network using a cluster of traffic flow controllers with a common registration database

(76) Inventors: Peter Leis, Penzberg (DE); Rainer Liebhart, Schrobenhausen (DE)

Correspondence Address: Siemens Corporation;Intellectual Property Department, 170 Wood Avenue South, Iselin, NJ, 08830, US

(21) Appl. No.: 10/493,252

(22) PCT Filed: Oct. 17, 2002
(86) PCT No.: PCT/DE02/03936

(30) Foreign Application Priority Data
Oct. 18, 2001 (DE) 101 51 443.3

(51) Int. Cl. G06F 15/16

(52) U.S. Cl. 709/232

(57) ABSTRACT

A cluster of traffic flow controllers comprises means for implementing a common registration database. Events relevant to registration that occur can be recorded in the traffic flow controllers of the cluster with the aid of said means. Said events and/or their consequences are then communicated to the other traffic flow controllers of the cluster.

### CROSS REFERENCE TO RELATED APPLICATIONS

This application is the US National Stage of International Application No. PCT/DE02/03936, filed Oct. 17, 2002 and claims the benefit thereof. The International Application claims the benefits of German application No. 10151443.3 filed Oct. 18, 2001, both of the applications are incorporated by reference herein in their entirety.

### FIELD OF INVENTION

The invention relates to the traffic flow control for a communications network.

### BACKGROUND OF INVENTION

The ITU-T Standard H.323 defines a family of protocols for the uniform control of services in multi-media packet networks (in particular IP networks), i.e. of networks in which a multiplicity of different services can be conveyed. These services, realized in a unified multi-media environment are also called ‘multi-media applications’. The term multi-media applications then covers not only such services as the usual telephony (keyword ‘Voice over IP (VoIP)’) but also such services as fax, telephone conferencing, video conferencing, Video on Demand (VoD) and other suchlike.

The main network components of the packet-oriented H.323 are end-points (units which wish to use applications, such as for example a PC client), gateways (GWs) for the interface into the line-oriented telephone network, multipoint control units (MCUs) for controlling conferences and gatekeepers (GKs).

Here, a gatekeeper controls access to the IP network for all H.323 components (end-points, GWs, MCUs) which belong to its zone. The following functions are assigned to a GK:
1) Admission control (network access control)
2) Call Authorization (authentication of individual connections)
3) Address Translation (conversion of the dialing information into IP addresses
4) Call Control Signaling (control of the connection setup and clear down, together with subscriber features)
5) GK Communication (communication with the GKs for other zones)

If the gatekeeper suffers a failure, the features mentioned above are no longer available for the end-points of the GK's zone, and in consequence nor are the services mentioned at the stat above. This means that, in particular, the voice service based on H.323 is no longer available. The end-points can thus neither establish connections themselves, nor can they be reached by other subscribers (from within the IP network or from the normal telephone network). However, as reachability by telephone enjoys a high priority for a subscriber, the availability of the service is exceptionally important for carrier-grade VOIP.

Until now, it has only been possible to ensure the availability of a GK by using high-availability and expensive devices. However, as such machines can fail, the number of units which fail must be kept as low as possible, i.e. the H.323 zone which a gatekeeper serves will consist of less end-points and gateways than the GK actually could control. This is a disadvantage in respect of the resources present and the investments made, because they cannot be utilized to the full extent of their capabilities.

### SUMMARY OF INVENTION

It is the object of the invention to indicate a way in which at least the availability of the VOIP service can be ensured for H.323 end-points without having to install high-availability and expensive GK servers.

It is proposed that several gatekeepers are combined to form a ‘gatekeeper cluster’ with a common registration database. The gatekeepers in a cluster would then jointly serve a registration zone, and share between them the control of the traffic volume.

In that the registration data is exchanged between the gatekeepers, which are preferably physically separate, the installation of expensive, high-availability servers is superfluous.

The end-points of the zone are aware of at least one primary GK together with at most one secondary GK. The remaining GKs present in the cluster are in general not directly visible to the end-points, even if this is not basically precluded.

Until now an end-point has registered itself, within its gatekeeper cluster, with its primary GK by means of the H.323 RRQ (Registration Request) message. If the primary GK is not available, the end-point registers itself with its secondary GK (standard procedure in H.323). The RRQ message is part of the socalled RAS (Registration, Admission and Status) message. So that the endpoint can now also be reached via any other arbitrary GK in the cluster, with which other end-points or gateways have registered themselves, with the present solution the registration data for an end-point is sent at periodic intervals to all the gatekeepers in the gatekeeper cluster, for example by means of a UDP multicast. In the reverse case, i.e. when an end-point logs off from a GK—also called ‘deregistration’—the same method is used to inform the other GKs in the cluster of this. This has the effect that all the gatekeepers in a cluster have identical registration databases.

is advantageous if the GKs in a GK cluster form their own multicast group, so that the multicast messages do not impose a load on the other hosts of the LAN segment in which the gatekeepers of the cluster are included. The additional network load for the exchange of the registration data is limited by the use of multicast messages, because the gatekeepers in a cluster form a well-defined closed multicast group. In addition, registration aid deregistration messages are not sent as often as any signaling messages for call set-up and connection release.

A nice advantage of the identical registration databases lies in the fact that gateways, end-points, MCUs or gatekeepers in other zones do not need to know for a particular end-point, which they wish to reach, the GK in the cluster with which it is registered.

For example, if a gateway sets up a connection to a GK with which the desired end-point did not register itself, this GK also has available the IP address (and any security data) of the end point, and can directly set up a connection to the end-point (so-called ‘direct routed call model’ of the H.323 standard). There is thus an H.323 RAS connection to a gatekeeper in the cluster, while the connection signaling does not pass through a gatekeeper, or at least not through this gatekeeper, but through another gatekeeper in the cluster. If, on the other hand, the desired end-point is registered with the same GK as is to carry out the connection set-up, the connection is established in accordance with the ‘gatekeeper routed call model’. By contrast, connections from the end-point to a destination always pass through the primary GK with which the end point is registered.

The end-points monitor the gatekeeper with which they have registered, by means of H.323 RRQ messages sent periodically, which the GK must answer. If the gatekeeper does not acknowledge the RRQ message, the end-point attempts to register itself with another gatekeeper of which it knows. This could, for example, be a so called secondary GK. Even if all the GKs known to an endpoint fail, it can still be accessed by the remaining GKs in the cluster, because they too have stored the profile of the end-point (which contains, in particular, the IP address of the end-point). An “intelligent” end-point can thus even learn the IP addresses of another gatekeeper, by recording its IP address when a call is made, and may then register itself with this gatekeeper (not only with the objective of being reachable, but also of being able itself to reestablish connections).

An advantageous possibility is to enlarge an H.323 zone in a simple way, by incorporating additional GK servers into the cluster. As part of the multicast group, these additional GKs can now establish connections to all the end-points which are registered with any of the GKs in the cluster. Endpoints which are added into the zone, or end-points which are already part of the zone, can then register themselves with the additional GKs.

Using the method presented here, it is possible to optimize the utilization of all the GK servers which are in use, resulting in an optimal use of the investments which have been made. The invention is thus a solution which ensures the reachability of individual subscribers in a very cost-effective way, hence at the same time making it possible to scale GK zones without great expense to accommodate growing numbers of subscribers, in that it is simple to install in a zone additional GK servers, which automatically split the traffic volume in the zone among themselves.

### BRIEF DESCRIPTION OF THE DRAWINGS

Further exemplary embodiments of the invention are shown in the figures. These show:

FIG. 1 an arrangement for performing the method in accordance with the invention, which includes a cluster CL with two gatekeepers GK₁, GK₂ together with a client EP and a gateway GW,

FIG. 2 a connection setup in the arrangement shown in FIG. 1.

### DETAILED DESCRIPTION OF INVENTION

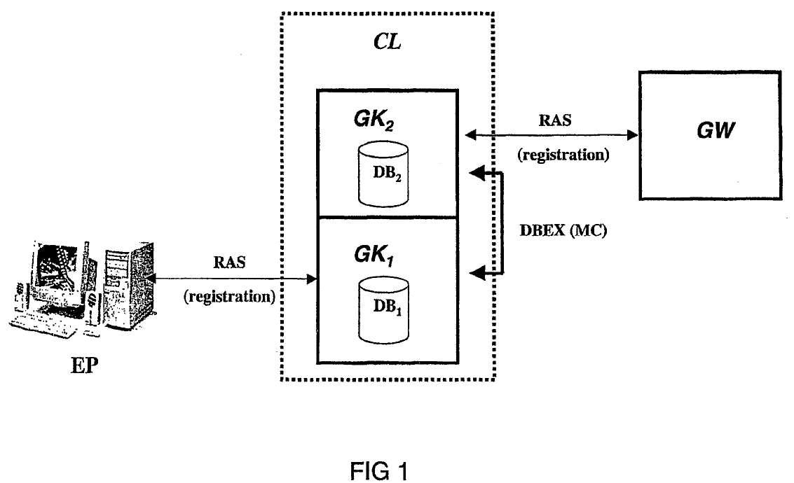

FIG. 1 shows the registration procedure for an H.323 end-point which takes the form of an H.323 client EP, and an H.323 end point which takes the form of an H.323 gateway GW. The H.323 client EP registers itself with its primary gatekeeper GK₁, the gateway GW with its primary gatekeeper GK₂, using the RAS (Registration, Admission and Status) protocol. The registration of the client EP is stored in the registration database DB₁ of the gatekeeper GK₁, that of the gateway GW in the registration database DB₂ of the gatekeeper GK₂. The gatekeepers GK₁ and GK₂ form a gatekeeper cluster CL in accordance with the invention. The registration data is exchanged between GK₁ and GK₂, for example over a shared LAN (Local Area Network) segment, in accordance with an exchange protocol DBEX, preferably implemented as a multicast MC. This means that the registration of the H.323 client EP is also known to the gatekeeper GK₂ and that of the gateway GW is known to the gatekeeper GK. The data (e.g. IP address, crypto token for secure message transmission, etc.) for all the registered end-points EP, MG is available to each of the gatekeepers, thus producing a common registration database.

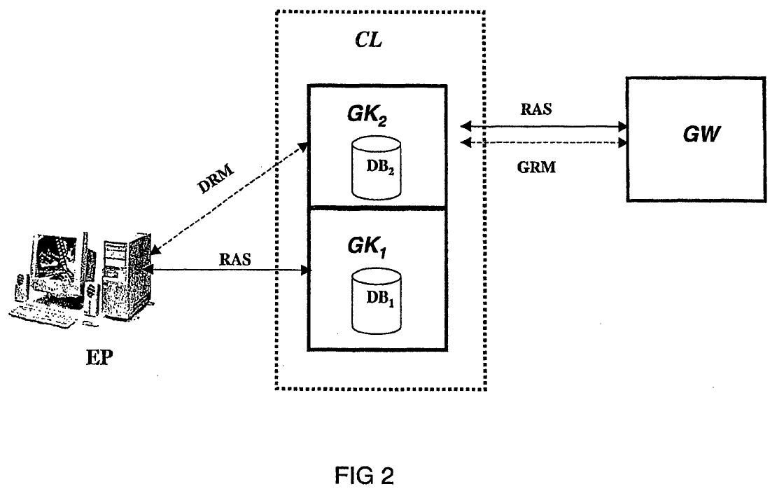

FIG. 2 shows the set-up of a connection from the gateway GW to the H.323 client EP. As the gateway is registered with GK 2, it sends RAS messages to this gatekeeper. A subsequent request for a connection set-up from the gateway GW to the client EP is consequently notified to the gatekeeper GK₂ in accordance with the gatekeeper routed model GRM. As GK₂ also knows the registration database DB₁ of the gatekeeper GK₁, and thus also has available the registration data of the H.323 client EP, it knows that the client EP is online, and it can forward the signaling messages from the gateway directly to the client EP, i.e. in accordance with the direct routed call model DRM. For its part, the client EP is registered with GK₁, from which it will thus query, by means of RAS messages, whether it may accept connections from the gatekeeper Gk₂. Because, in accordance with the invention, gatekeeper GK₁ knows the registration database DB₂ of the gatekeeper GK₂ in the cluster CL, gatekeeper GK₁ can send back to the client EP a positive confirmation of its query.

It must be emphasized that the description of the components relevant for the invention is basically not to be interpreted in a restrictive manner. In particular, it will be clear to the appropriate specialists that terms such as ‘end-point’, ‘gateway’ or ‘gatekeeper’ must be interpreted in a functional sense and not physically. Hence they could, for example, also be realized partially or wholly in software, and/or distributed across several physical devices.

1.-14. (canceled)

15. A method for the common control of traffic in a zone of a network by a cluster of at least two gatekeepers, comprising:
occurring of an event relevant to the control function at a gatekeeper in the cluster;
notifying the other gatekeeper in the cluster of the event and/or its consequences; and
effecting the common control of the traffic by at least one of the gatekeepers in the cluster, taking into account the notified event.

16. A method in accordance with claim 15, wherein the event is a registration or a deregistration of an end-point.

17. A method in accordance with claim 15, wherein an end-point, if it receives a message from a gatekeeper which until then was unknown to it, stores the gatekeeper's address.

18. A method in accordance with claim 15, wherein the end-point registers itself with the gatekeeper which until then was unknown to it.

19. A method in accordance with claim 15, wherein the end-point registers itself if the one or more gatekeepers with which it is already registered is no longer reachable.

20. A method in accordance with claim 15, wherein the gatekeepers are physically separate entities.

21. A method in accordance with claim 15, wherein an individual registration database is assigned to each gatekeeper.

22. A method in accordance with claim 15, wherein the event is communicated to the other gatekeepers in the cluster by messages.

23. A method in accordance with claim 15, wherein the messages are multicast messages.

24. A method in accordance with claim 16, wherein an end-point, if it receives a message from a gatekeeper which until then was unknown to it, stores the gatekeeper's address.

25. A method in accordance with claim 16, wherein the end-point registers itself with the gatekeeper which until then was unknown to it.

26. A Method in accordance with claim 23, wherein the cluster is so configured that the multicast messages are received only by the gatekeepers in the cluster.

27. A gatekeeper connected to a second gatekeeper in a cluster of at least two gatekeepers within a communications network, comprising:
a mechanism for observing events within the network;
a mechanism for notifying the second gatekeeper in the cluster of the event and/or its consequences;
a mechanism for communicating data with the second gatekeeper; and
a mechanism for effecting a common control of traffic by at least one of the gatekeepers in the cluster, taking into account the notified event.

28. A gatekeeper connected to a second gatekeeper in a cluster of at least two gatekeepers within a communications network, comprising:
a mechanism for receiving events notified by a first gatekeeper;
a mechanism for communicating data with the second gatekeeper; and
a mechanism for effecting a common control of traffic by at least one of the gatekeepers in the cluster, taking into account the notified event.

29. A gatekeeper in accordance with claim 28, wherein the gatekeeper is part of a cluster of identical gatekeepers.

30. A gatekeeper in accordance with claim 28, further comprising a mechanism for realizing a common registration database.

31. A computer program product for performing a method for common control of traffic in a zone of a network by a cluster of at least two gatekeepers, the method comprising:
occurring of an event relevant to the control function at a gatekeeper in the cluster;
notifying the other gatekeeper in the cluster of the event and/or its consequences; and
effecting the common control of the traffic by at least one of the gatekeepers in the cluster, taking into account the notified event.
